(19) United States
(12) Patent Application Publication
(10) Pub. No.: US 2008/0198422 A1
(43) Pub. Date: Aug. 21, 2008

(54) Contextual Management of Multiple Device Capabilities in a Communication Device

(76) Inventors: Tamara Lynne Casey, Henderson, NV (US); David P. Martin, Chantilly, VA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/676,400

(22) Filed: Feb. 19, 2007

(51) Int. Cl. H04J 15/00

(52) U.S. Cl. 358/425

(57) ABSTRACT

A communication device invokes its various device capabilities according to context information about the device. Events, which may be initiated by a user or may occur without direct user involvement, are mapped to the various functions that implement the capabilities of the device. The mapping may be updated dynamically and automatically as the context information changes and new context information received. User data and system data are also stored as the data are accumulated. When an event occurs, one or more functions that are associated with the event according to the current mapping are invoked. The user and system data may also be passed on for use with the invoked functions.

### BACKGROUND

This invention relates generally to communications systems, and in particular to implementing multiple services, applications, and/or or functionalities in a communication device.

In devices capable of hosting multiple communications services, such as in cellular phones, an ambiguity may arise about how user-generated actions and other events that may occur should be handled. One cause of this ambiguity is that multiple applications may concurrently interface with shared resources, such as a user interface, a database, a file system, or some other software and/or hardware resource used by the device. An example of an ambiguous user event could be a user selection of a button on the device, while an example of an ambiguous service event could be writing to a file that is being accessed by another service used by the device.

Traditionally, events that invoke a device's functionality have been managed by applications that “listen” for particular events, such as a certain button being pressed. When the application is notified that the event has occurred, the application's logic is executed to handle the event. In this traditional model, there is a one-to-one mapping of the application to the event. But in communication devices there are typically several applications that may be invoked for various services. On a cellular phone, for example, there may be separate applications for voice calling, SMS messaging, MMS messaging, push to talk (PTT) communications, and many others. Even in an environment where multiple applications are available to the user, the user interface is still under the control of a single application at any given time. To prevent ambiguity and avoid resource conflicts, only a single application handles an event, and in most cases the other applications are never informed of the event.

These traditional approaches are limited in the way they allow existing services to interact and in the way that additional services can be integrated or existing services reconfigured. Because each application defines the interfaces that the user can access, control over the device is by the application. Although the multiple services or applications can share the capabilities of the device and its user interfaces, interactions between different services are only possible by changing the applications providing those services. Moreover, these interactions, if any, are typically done in a static, predefined, and pre-programmed fashion that does not take into consideration the context or the user behavior.

### SUMMARY

To avoid the limitations described above, a communication device includes a context engine that implements a set of rules and logic for mapping events that may occur with respect to the communication device to the device's functions. Controlling the device functionality is thus handled by a central mechanism that resolves any ambiguity about which device capabilities are invoked upon various events. The resources and capabilities can then be shared by multiple applications (or services) according to a static, rule-based or dynamic and contextual based schema.

In one embodiment, a communication device invokes its various device capabilities according to context information about the device (such as the geographical location of the device or whether the device is in a particular state). Events, which may be initiated by a user (e.g., a button press) or may occur without direct user involvement (e.g., a low battery state), are mapped to the various functions that implement the capabilities of the device according to certain rules. The context engine in the communication device may update this mapping dynamically and automatically as the context information changes and as new context information is received. User data and system data are also stored in a data catalog as the data are accumulated. When an event occurs, an event handler in the communication device invokes one or more functions that are associated with the event according to the current mapping. The user and system data may also be passed on for use with the invoked function or functions (e.g., the content of a text message entered before the invocation of a text message function).

In this way, a communication device implements its functionalities in a context-dependent manner using a mechanism that acts as a layer between the device's capabilities and the lower level code that implements the device's capabilities. In this way, ambiguities regarding which functions should be invoked to handle various events are resolved, and new functionalities and services can be more easily added to the communication device without requiring extensive redesign of existing functions, applications, and services. This mechanism thus provides for improved interoperability and services interaction over traditional architectures that use hard-coded applications and enables easier introduction of new services and functionalities in the communication device.

### BRIEF DESCRIPTION OF THE DRAWINGS

FIG. 1 is a diagram of a mapping between events that may occur with respect to the communication device and the functional capabilities of the communication device, in accordance with an embodiment of the invention.

FIG. 2 is a flow diagram for a method of implementing a functionality of a communication device, in accordance with an embodiment of the invention.

FIG. 3 is a schematic diagram of a communication device, in accordance with an embodiment of the invention.

FIG. 4 is a diagram of a portion of a mapping using a decision tree, in accordance with an embodiment of the invention.

FIG. 5 is a diagram of a portion of a mapping using a set of templates, in accordance with an embodiment of the invention.

FIG. 6 illustrates the adjustment of a mapping in the form of a matrix, in accordance with an embodiment of the invention.

### DETAILED DESCRIPTION

### Context-Dependent Invocation of Device Capabilities

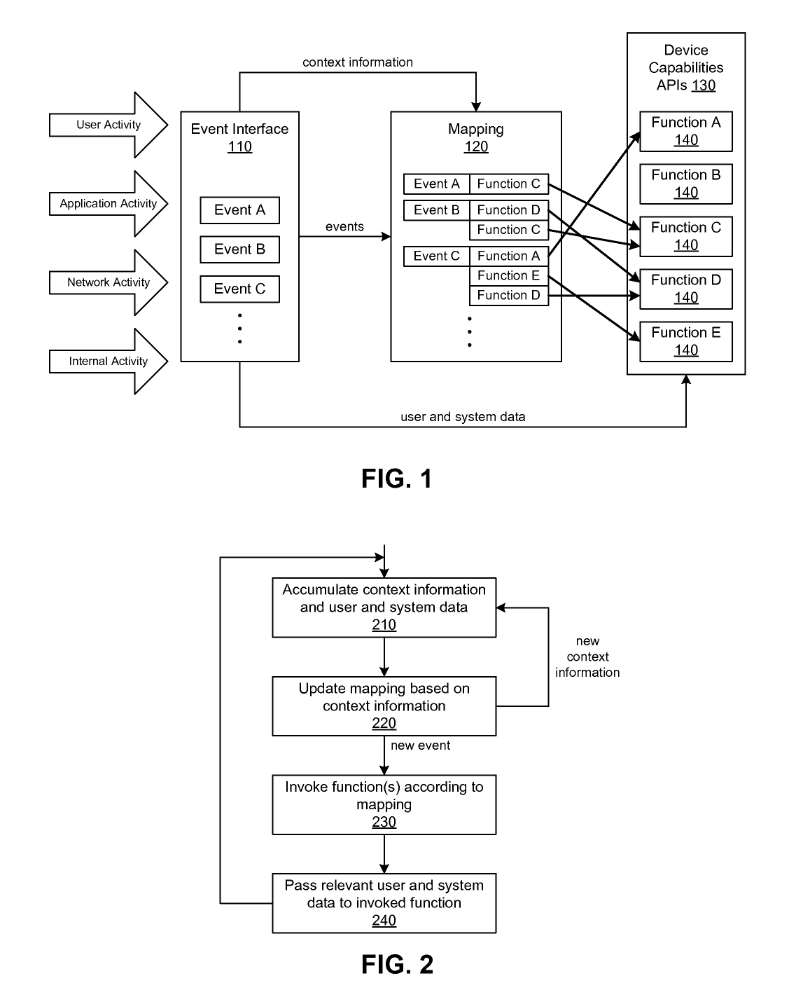

FIG. 1 illustrates how the capabilities of a communication device can be invoked in response to various activities and based on current context information about the communication device. The capabilities of a communications device may include hardware or software elements that reside in the device and can be used to execute a specific function or set of functions (e.g., a GPS API, codec APIs, a microphone, a screen, a keypad, and many others). In a communication device, use of the device capabilities enables the user to use the device to take advantage of various services, such as voice calling, messaging, and data services. Services are typically products that a user subscribed to and is charged for use thereof, often by metering the user's access to the services. A service may be implemented by a collection of functions, applications, and/or other services that can be called and executed in any order. Usually accessed through a user interface, the behavior of a service typically depends on the user input and possibly other events.

Functions constitute the atomic level in the structure of a service. A function fulfills a specific and task or tasks, and the behavior of a function is typically deterministic and its outcome or result well-defined. A function can be implemented in software and/or hardware and may or may not have direct interaction with the user. Applications constitute the molecular level in the structure of a service. An application is composed of one or more functions that interact with each other and with other device capabilities to produce a result based on the user input and/or contextual information. Traditional applications comprise a determined set of functions with a deterministic behavior and a pre-defined outcome or results based on the user input. However, an application may be thought of as any bundle of functions, which in embodiments of the invention are determined according to dynamic context information concerning the device. The specific outcomes or results when such an application is invoked may thus depend in each instance of the user input, user configuration, and/or other contextual information about the communication device.

For a typical communication device, a wide range of different activities may affect the operation of the device. These activities may be classified according to the entity that invokes the activity, such as users, applications, and networks, or even internally by the device itself. For example, user activity is invoked or triggered by a user, such as a series of key presses to make a new phone call. Application activity is invoked or triggered by an application or function, such as the receipt of a new email message. Network activity is invoked or triggered by the device's connectivity with a network or other network-related events, such as the loss of signal. Finally, internal activity is invoked or triggered by activity within the device itself, such as the battery level dropping below a predetermined level or a sensor (such as a thermometer) reaching a predetermined threshold value.

The activities that can affect the operation of the device may also be classified as discrete actions made by an entity or as threshold actions that are defined based on the status of an item with respect to a threshold value. The following table provides examples of discrete and threshold activities from various different entities.

| | Discrete Actions | Threshold Actions |
|---|---|---|
| User | pushing a button | repeated sequence of key presses |
| Activity | voice input | exceeding a threshold |
| | docking the communication | user inactivity for a pre-defined |
| | device in a cradle | period |
| | closing a flip phone | |
| Application | sending or receiving an email | GPS coordinates are within defined |
| Activity | calendar reminder | range |
| | making or receiving a phone call | speed calculated from GPS exceeds |
| | presence update | a threshold |
| | application starting or ending | number of incoming calls from |
| | communication session | same phone number within a period |
| | | exceeds a threshold |
| Network | loss of signal | packet errors within period exceed |
| Activity | change in IP address | threshold |
| | hand off to different base station | signal drops below threshold value |
| | acquisition of a WLAN | |
| | detection of a Bluetooth device | |
| Internal | internal software error | low battery condition reached |
| Activity | screen saver invoked to dim | device free memory less than |
| | screen | minimum value |

The examples provided in the table above are for illustration of one embodiment only, and many other types of activities may be relevant to other embodiments of the communication device. It can be appreciated therefore that the activities used in connection with embodiments of the invention may broadly include any types of actions that are desired to invoke a capability of the communication device.

The types of activities in the table above correspond to the activities illustrated in FIG. 1. As illustrated, these activities are observed by an event interface 110 of the communication device. The event interface 110 is thus coupled to any instrumentalities in the communications device that allow it to observe these events. The event interface 110 is configured to generate one or more events depending on the activities it observes. For certain activities, the event interface 110 may generate more than one event, whereas for other activities it may generate no events. For example, when a user inputs a series of digits (e.g., before dialing a phone number), that user activity may not trigger the generation of an event by the event interface 110. However, once the user presses a “call” button, a corresponding event is generated.

The event interface 110 may also derive data concerning the communications device while it is observing various activities. In the example above, when a user inputs a series of digits before making a call, the event interface 110 does not trigger an event for this user activity. However, the event interface 110 may pass this user data on to a data catalog, which stores the user data for possible use at a later time (which process is described in more detail below). Similarly, other information observed by the event interface 110 may comprise context information, which describes something relevant about the state of the device or past activities related to the device. As described in more detail below, the context information may be used to define or adjust a mapping 120 of the generated events to one or more functions 140 in the device.

The communication device comprises a mapping 120 of a set of events to a set of functions 140. This mapping 120 associates each of the possible events that might occur with respect to the device to the device's capabilities, which may be functions 140 that provide service to a user. The functions 140 may simply be a call to execute an application in the device that implements a specific service, such as an email or IM application. Alternatively, the functions 140 may be lower level code (e.g., a device driver, library function, a protocol stack, or user interface widget) that can be combined to provide a service to the user. For example, the function 140 may include a set of functions that take a picture with a built-in camera, bundle the picture in a MMS message, and send the MMS message to a selected recipient. The latter approach allows developers to make basic software functions for a particular device without writing specific applications, which makes adding new services and modifying existing ones easier and may allow a user to create customer services that leverage the basic device capabilities. Further, the functions 140 may comprise user interface functions that present information to a user via the device's display, via an audio message, or via anything other output mechanism of the device.

As illustrated, the mapping 120 associates events to the functions 140 via a device capabilities API 130. This may simplify the structure of the mapping 120, allowing the mapping 120 to reference a command in the API 130 rather than one or a series of functions 140. In other embodiments, the mapping 120 may directly reference the functions 140, which may be complete applications running on the device.

In the example provided in FIG. 1, the event interface 110 generates events A, B, and C based on the received activities. These events are associated with one or more functions 140 by the mapping 120. Accordingly, event A maps to function C; event B maps to functions D and C; and event C maps to functions A, E, and then D. This causes the corresponding functions to be called as specified by the mapping 120 for each of the generated events. Depending on the functions invoked, user and system data collected during the activity may be passed to the invoked functions. In addition, the mapping 120 may change if new context information is received during the activity.

FIG. 2 illustrates a general process flow in which the communication device implements a function based on context information about the device and/or the user, according to an embodiment of the invention. As described herein, the communication device uses context information policies (which can be defined by the operator, user, or the manufacturer) to resolve ambiguities about which device capabilities are invoked to respond to events. As illustrated, therefore, the device accumulates 210 context information about the device, user, network, and any other observable phenomenon as that information occurs, based on the various types of activities that may be observed.

The accumulated context information may include a wide variety of information that may be useful in determining which device capability should be invoked in response to an event. Without limitation, the context information about the device may include the history of user's actions, such as button presses and other functions previously invoked; location information about the device, which may be acquired from a GPS module or similar equipment in the device; the speed of travel of the device, which may be calculated from the location information; the battery life remaining in the device; presence information about the user or about another individual in a contacts or a buddy list on the device; a particular mode the device is in (e.g., if a camera is on or whether the phone is docked); the signal strength of a communications network, such as a cellular network; the presence of a particular communications network, such as a WiFi or Bluetooth network; and/or any information about the device and/or the user of the device that could be used to determine which functionality of the device should be invoked in response to various events. The order in which the context information occurs or is acquired may also be part of the context information.

The device may also accumulate 210 user data, which may be used in connection with an event to invoke a function call 140 at a later time. The accumulated user and system data may overlap with the accumulated context information, but it need not and typically would not be identical to it. The user data may include any data that may be passed to or used in connection with a device capability, and the user data typically comprises a series of actions taken by the user. For example, and without limitation, the user data may comprise a number, to be used to dial a phone number; a string of characters, for inclusion in a SMS message or email; an audio file, such as a voice file for sending as a PTT message; a picture file, which may be stored locally or bundled in a message; or any other type of information usable in connection with a device capability or service. To keep track of the order in which the user data is received in the device, the device may store the user data in a stack. In the stack, textual and numerical user data may be directly stored, while voice files and other larger data may be stored in a different area (such as a device memory or an adjunct memory card) with a pointer or other reference to the data in the stack. The system data may comprise any information describing the state of the device, including applications loaded on the device, CPU and memory information, connectivity information, and any of a variety of state data about the device.

As described, the communication device uses the context information to update 220 the mapping 120 between the events and the device capabilities. This updating 220 may be performed dynamically and automatically whenever new context information is received, as shown in FIG. 2. Keeping the mapping 120 current at all times may help to reduce response times within the communication device. Alternatively, the communication device may keep track of the context information and wait until an event occurs before updating 220 the mapping 120. This may avoid changing the mapping 120 as often, but may also result in more lag time due to the additional processing that occurs upon an event.

When the communication device receives an event (e.g., when the event is generated by the event interface 110), the device invokes 230 the function 140 that is associated with the event according to the mapping 120. A variety of events may be defined for the communication device. In one embodiment, an event is simply a trigger that causes the device to perform a function 140 in response to the event.

Upon invoking 230 a function 140, the communication device may pass 240 any collected user data to the invoked function 140. Different functions 140 may use different types of user data, and some may not use any. Accordingly, the communication device may be configured to pass 240 only those types of user data that are appropriate for the invoked function 140. The communication device may also be configured to pass 240 data according to policies that are defined by the user, the operator, the device manufacturer, and/or the application provider. In an embodiment where the user data are stored in a stack, the functions 140 may be programmed to search the stack for any needed or appropriate user data. For example, a function 140 that initiates a voice call may search the stack for a numerical string having an appropriate number of digits. The numerical string may not be the top or most recent addition to the stack, such as if the user data collected location information about the communication device. If the location information is irrelevant to the invoked function 140, the function 140 may ignored that user data and just use the appropriate data type in this case, the numerical string.

The following example illustrates one implementation of the process described above. While talking on a phone, a user might scroll through a directory of pictures stored on the communication device and then press a “send picture” button on the phone. The context information that is accumulated 210 during this process may include the fact that the user was talking on the phone and that the user was scrolling through a directory of pictures. The user data accumulated 210 may be the number or identity of the person to which the user was talking and the selected picture file. The pressing of the “send picture” button is a user action that caused the generation of an event, which in turn caused the device to invoke 230 one or more functions 140 to send the selected picture file to the person to which the user is talking. The device passes 240 the picture file and the identity of the other caller (i.e., the user data) to the invoked functions 140, which then send the selected picture file to the other caller, e.g., over a separate data network. Although this one example is provided, it can be appreciated that the techniques described herein can be used to implement any device capability as desired by a designer.

### Communication Device Architecture

The communication device may comprise any kind of device, whether portable or stationary, that can be used for any type of communications between or among two or more information sources, or from a single information source to one or more devices (such as in the case of a broadcast). Such devices include, without limitation, wireless and wired communications devices, mobile communications devices, receive-only devices, broadcast devices, cellular phones, smart phones, personal digital assistants (PDAs), pagers, other handheld devices, monitors and monitoring systems, meters, data acquisition systems, computer systems (including laptops and other portable or stationary systems), communication software running on a computer system, and any other system that enables electronic communications. Although not limited to any particular type of set of communications, the services enabled by embodiments of the invention may include voice calling, SMS and/or MMS messaging, instant messaging (IM), push-to-talk (PTT), email, and data services. The communications devices may also have functionalities that do not directly involve communications, such as internal cameras, voice recorders, calendars, organizers, contacts, games, and any of a variety of other applications or features.

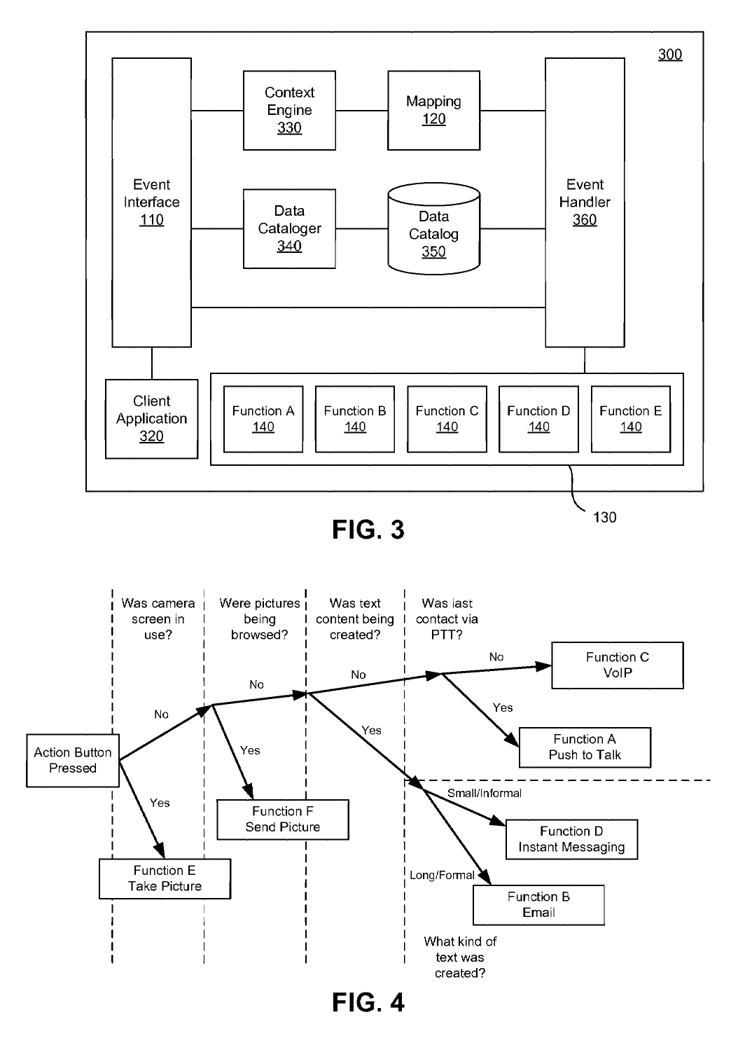

FIG. 3 is a block diagram of a communication device 300 in accordance with one embodiment of the invention. This embodiment of the communication device 300 includes an event interface 110, a mapping 120, and the device capability API 130 with functions 140, as described conceptually in FIG. 1. The device 300 may also be configured to perform the process illustrated in FIG. 2.

As described, the event interface 110 communicates with any number of device mechanisms (such as a device CPU, a user input interface, a network interface, and various other functional modules) for observing various types of activities for which events are to be generated. The event interface 110 may also communicate with any internal client applications 320 supported by the device 300. In one example in a cellular phone context, the internal client application 320 may be a camera application that handles the capture of pictures and video using built-in camera hardware in the device. There may be multiple internal client applications 320 in the communications device 300. Accordingly, the event interface 110 comprises any code necessary to interface with the external services and/or internal client applications 320. For legacy services and/or client applications, the event interface 110 may comprise a wrapper application that handles any special data formatting and other adaptation needs of the legacy software. The event interface 110 may further comprise software service agents to assist in handling communications with the services and client applications 320.

In a typical implementation, the event interface 110 is also configured to receive context information, user data, and system data about the device 300 from any one or more the services, internal applications, and any other resources available to the device 300. For example, context information obtained from a network service may be the signal strength of a wireless network, context information from a client application 320 may be location information from an internal GPS module, and context information from a user interface module may be that the device 300 was placed in camera mode based on the pressing of a corresponding button on a keypad of the device 300. Similarly, user data from a service may be a file downloaded using a data service, user data from a client application may be a picture taken from a built-in camera, and user data from the user interface module may be a phone number for use in making a new phone call. Moreover, system data such as installed application lists and device states may be obtained from shared device resources, such as a memory in the device. It can be appreciated that these are merely examples of the ways in which the event interface 110 can obtain context information, user data, and system data from various sources, both external and internal, depending on the design of the particular communications device 300.

The event interface 110 is coupled to a context engine 330 to provide the context engine 330 with context information that it receives from any of the sources described above. The context engine 330 then modifies the mapping 120, if necessary, based on the received context information. In one embodiment, the context engine 330 includes a set of rules that it applies to determine an appropriate mapping 120 between the events and the functions 140. The rules within the context engine 330 determine how the device 300 responds under various circumstances, and as such they are left up to the designer of the communication device 300 to program the desired functionality for the device 300. In one embodiment (described in more detail below), the mapping 120 comprises a decision tree, and the context engine 330 adjusts the decision tree if needed upon receiving new context information. In another embodiment (also described in more detail below), the mapping 120 is taken from a template that relates events to functions 140, and the context engine 330 chooses a template from a set of predetermined templates based on the received context information.

The event interface 110 is also coupled to a data cataloger 340 to provide the data cataloger 340 with user and system data that it receives from any of the sources described above. The data cataloger 340 is programmed to receive the user and system data from the event interface 110 during operation of the communication device 300. The data cataloger 340 then stores the user and system data in a data catalog 350. As described above, the user data may be stored as a stack of information, with pointers or references to user data that is larger (such as picture files).

When the event interface 110 generates an event in response to an observed activity, as described above, the event interface 110 provides the event to an event handler 360. In response to receiving the event, the event handler 360 reviews the mapping 120 to determine the proper function 140 (or multiple functions 140) to invoke in response to the event. As described herein, the mapping associates the functions 140 to be invoked for each event that may occur based on the current context information for the device 300. The event handler 360 thus invokes one or more functions 140 according to the mapping 120. Each function 140 exposes a capability of the communication device 300 and may be a single function or may call a complete application. Although shown within the device 300 in FIG. 3, the functions 140 are not necessarily all executed on the communication device 300 itself. In one embodiment, one or more of the functions 140 run on an adjunct processor (e.g., a SIM card, PCMCIA card, or any other processor coupled to the device), on a connected machine (e.g., on a personal computer, where the communication device acts as a modem for the computer), or on a remote device (e.g., where the function 140 is a device management function running on the operator's network).

If appropriate based on the type of function 140 invoked, the event handler 360 may also pass user data that it obtains from the data catalog 350 to the function 140. The event handler 360 may attempt to pass the most recent user data added to the data catalog 350, but it may also be configured to ignore user data that is not appropriate for a particular function 140. For example, if the most recent entry in the data catalog 350 is a picture file and the second-most recent entry is a valid phone number, and if the invoked function 140 is a voice call function, the event handler 360 may ignore the picture file and pass the phone number instead. Each function 140 may include instructions for the event handler 360 that indicate what types of user data the function 140 will accept as valid. If no valid user data is present in the data catalog 350, the event handler 360 may avoid invoking the function and instead run any error handling script in its place. When an item in the data catalog 350 is “used up” by being passed to a function 140, the event handler 360 may delete that item from the data catalog 350.

In one embodiment, the context engine 330 is configured to generate context information based on historical data, which describes historical activity that would typically have occurred over a long period of usage of the device. The historical activity may include historical user activity with the communication device, historical application activity, or historical network activity. Accordingly, the context engine 330 may include or be in communication with a data storage module for storing and retrieving data describing historical activity (e.g., an event log). The context engine 330 may then apply a particular algorithm to determine any useful context information based on this historical activity. Based on that historical activity, the context engine 330 adjusts the mapping 120, and the mapping 120 causes the event handler 360 to call different functions 140 upon certain events. In this way, the device can be made to train itself over time to provide more effective customized functionality for a particular user of the device. Any of a variety of algorithms may be used for adapting the device behavior (i.e., by adjusting the mapping 120) based on the historical activity, including those based on artificial intelligence (AI), neural networks, and any other algorithms as desired.

For example, a designer may decide that a device's messaging functionality should automatically default to a message type that a user has shown a historic tendency to prefer. The context engine 330 might then gather data about the type of message (e.g., SMS, MMS, email, etc.) that a user sends using the device each time a message is sent. Once a threshold test is met (e.g., more than 20 messages sent, and more than 75% of those are SMS messages), the context engine 330 determines that the historical activity is that there is a tendency to prefer SMS messages over other message types. The context engine 330 then adjusts the mapping 120 accordingly. For example, the new mapping 120 may affect the functions 140 that are called when a user presses a “reply” button when reading a message. Rather than replying using the same message type (e.g., when reading an email), the historically preferred message type (i.e., SMS) may be used as the default for the reply message.

### Updating the Mapping Based on Context

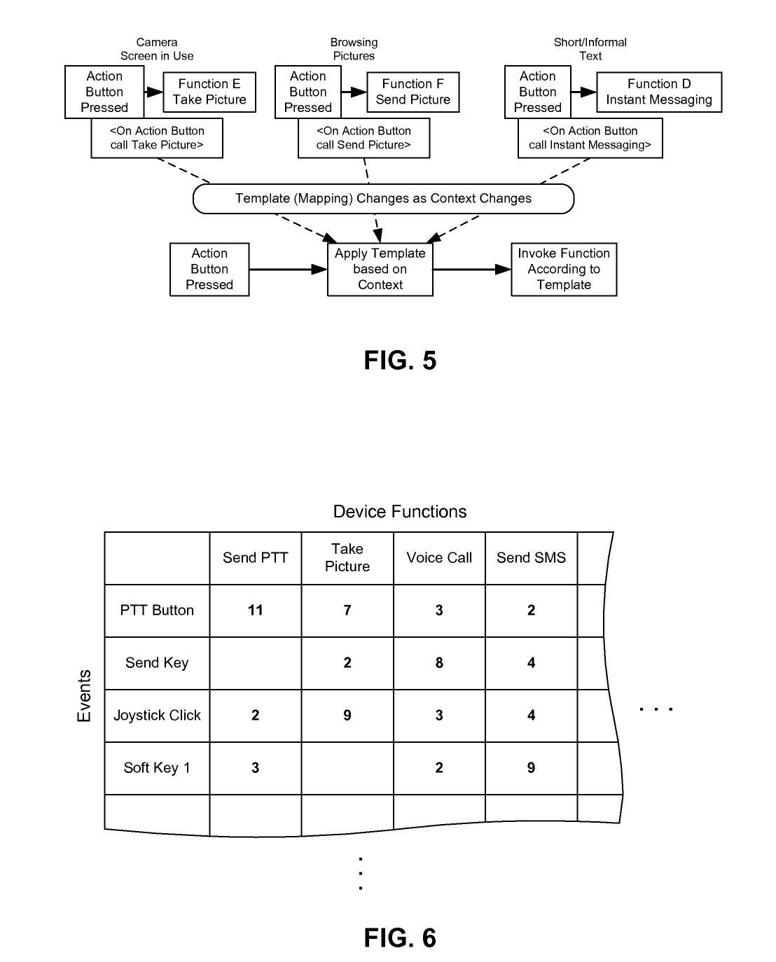

FIGS. 4 and 5 illustrate two possible approached for implementing the mapping described above. In FIG. 4, the mapping is implemented as a decision tree, and in FIG. 5 the mapping is implemented as a set of templates.

FIG. 4 logically illustrates a decision tree that may be implemented in computer code as a series of conditional tests. The decision tree comprises logical branches for each contextual condition that may be relevant to determining the function to invoke in response to a given event. To determine the appropriate function in response to a particular event according to this mapping, the tests in the decision tree are applied sequentially. The tests typically test one aspect of context information collected by the communication device. If the result of a test branch results in a clear function, that function will be invoked. Otherwise, the condition at the next branch is evaluated according to the context information. Each contextual condition is evaluated in turn until a clear function is found without ambiguity, or until the end of the tree is reached and a default action is then invoked.

In the method illustrated in FIG. 5, the mapping is provided by selecting a particular template from a set of possible templates. Each template indicates which function should be invoked should a particular event actually take place. In one embodiment, the context information about the device is continuously monitored. Whenever one (or more) of a set of predetermined contextual conditions is met, the corresponding template is then selected to replace the current template being applied. In this way, the template is updated using the context information in anticipation of the particular event's occurring. If that event does occur, the device determines the appropriate function based on the most recently selected template. This updating of the mapping by template substitution may occur in the background and the corresponding code for the functions may be pre-loaded into memory. This may improve the response time of the device when an event does occur.

These approaches may be implemented separately or may be designed to complement each other. For example, a set of templates could be used, where each template includes a more specific (i.e., smaller) decision tree instead of directly identifying which function to invoke. In that way, a template would be selected based on current context information (as described above, and the template provides a decision tree that is used to determine the appropriate function upon an event. Alternatively, a decision tree could be used as a mechanism to update templates rather than directly invoke a function.

In another embodiment, the mapping is implemented as a matrix, a portion of which is illustrated in FIG. 6. In the matrix, the events that may occur are located along one axis, and the device capabilities (expressed, for example, as functions) are along the other axis. In one embodiment, a numerical value is located at each position in the matrix, corresponding to a particular event and function. The numerical value is used to select which function or functions will be selected if the corresponding event occurs. In one implementation, the function with the highest numerical value for a given event is the function that is invoked when that event occurs. (The matrix may omit or set to a null value any numerical values for pairs of events and functions that will never be selected, or those values can be set to zero or some predetermined minimum.) In this way, the matrix allows for a many-to-many mapping of events to functions, where the mapping is adjustable by adjusting the numerical values in the matrix.

In the example shown in FIG. 6, if a user presses the PTT button, the matrix maps that corresponding event to the “Send PTT” function because that function has the highest numerical value corresponding to that event. As described above, the function would be passed user data, which in this example would comprise a sound file containing a short voice message recently recorded on the communication device. The function would then use that user data to send a PTT message to a user to which the device is connected using a PTT service available to the device. Moreover, the numerical values in the matrix may change based on a change in the context. For example, a user may then check a missed call log in the device and see that someone had attempted to send the user a PTT message, so the user may wish to respond to the other person with a PTT message. Based on this context (i.e., that the user just checked a missed call log containing a missed PTT message), it is likely that the user would want to invoke the PTT function. The mapping is thus changed to increase the value associated with the PTT function for a particular button so that when the user registers the message and pushes the button, a PTT message is sent and either delivered to the other person or to that person's voicemail if not available.

In another example with the matrix of FIG. 6, the user may enter a series of digits with the device's keypad, causing the device to add this information to the user data that it stores. If the user then presses the Send key, the device uses the matrix to determine that the “Voice Call” function should be invoked and that the digits entered be passed to that function. As context information changes, the mapping in the matrix may also change as described herein. For example, if the phone is placed in camera mode so that the image from a built-in camera is being viewed on the device's screen, the numerical value corresponding to the “Send Key” event and the “Voice Call” function may be decreased from 8 to 5 and the numerical value corresponding to the “Send Key” event and the “Take Picture” function raised from 2 to 9. Thereafter, if the user presses the Send key in this state, the device invokes the “Take Picture” function (and, in a more likely scenario, the device takes the picture and automatically sends the picture to another user's device) because that function now has the highest value in the matrix. In this way, the values in the matrix can be adjusted to result in a different mapping of events to functions based on context information.

In some embodiments of a communications device, the device may have the ability to run multiple sessions. For example, a user may use the device to make a voice call over a cellular network while also using a data connection to browse the Internet. The possibility of multiple sessions leads to the possibility that an event for one of the sessions will interfere with the other session by accidentally invoking a function for the other session. In one embodiment, this is addressed by adding an additional mapping (such as in the form of a matrix described herein) that corresponds to each session. The device then handles events allocated for each session and applies those events to determine functions to invoke based on these separate mappings. Where a matrix is used to provide the mapping, multiple sessions may alternatively be handled simply by adding a third dimension to the matrix. Each value in this third dimension then corresponds to a separate session. In this way, separate mappings can correspond to each of the sessions, and each of the mappings can be separately adjusted for the context information. This may be useful when the context information is relevant in different ways for the different sessions.

In one embodiment, the numerical values in the matrix may be accessible and can be adjusted manually by multiple entities. Entities who may wish to adjust the matrix may include one or more of device manufacturers, OEMs, application developers, carriers, service providers, and end users. In one embodiment, each of these entities may be assigned its own individual weight so each numerical value in the matrix is the weighted average of the corresponding numerical values set by each entity. Entities such as manufacturers and carriers may be assigned a larger individual weight than the other entities, like applications developers and end users, thereby giving those entities more control over the resulting values in the matrix. The individual weights for each entity may be kept in a single table, and the matrix can be obtained from a simple weighted average of each entity's matrix, value-by-value. In another embodiment, one or more of these entities may also be able to modify the rules by which the matrix is updated, or more broadly, how the mapping is adjusted based on a change to the context information. This ability to modify the rules for updating the mapping may be subject to a security mechanism to prevent unauthorized tampering with the device functionality (e.g., by users, third-party developers, or malicious code).

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

Some portions of above description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system or similar electronic computing device, which manipulates and transforms data represented as physical (electronic) quantities within the computer system memories or registers or other such information storage, transmission, or display devices.

Embodiments of the invention also relate to an apparatus for performing the operations herein. This apparatus may be specially constructed for the required purposes, or it may comprise a general-purpose computing device selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium and modulated or otherwise encoded in a carrier wave transmitted according to any suitable transmission method.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, embodiments of the invention are not described with reference to any particular programming language. It is appreciated that a variety of programming languages may be used to implement various embodiments of the invention as described herein, and any references to specific languages are provided for disclosure of enablement and best mode of embodiments of the invention.

Finally, it should be noted that the language used in the specification has been principally selected for readability and instructional purposes, and it may not have been selected to delineate or circumscribe the inventive subject matter. Accordingly, the disclosure of the embodiments of the invention is intended to be illustrative, but not limiting, of the scope of the invention, which is set forth in the following claims.

1. A method for implementing context-dependent functionality in a communication device, the method comprising:
associating a set of events with a set of one or more functions of the communication device according to a mapping;
tracking context information related to the communication device;
adjusting the mapping dynamically and automatically based on the tracked context information of the communication device; and
responsive to observing an event, invoking one or more functions associated with the event according to the mapping.

2. The method of claim 1, wherein one or more of the functions are applications that access a functionality of the communication device.

3. The method of claim 1, wherein one or more of the functions are library commands that access a functionality of the communication device.

4. The method of claim 1, wherein one or more of the functions are a protocol stack.

5. The method of claim 4, wherein invoking the functions comprises passing at least some of the accumulated user data to the invoked function.

6. The method of claim 1, wherein one or more of the events are application requests.

7. The method of claim 1, further comprising:
accumulating user data during operation of the communication device.

8. The method of claim 1, wherein the communication device is a mobile communication device.

9. The method of claim 1, wherein the communication device comprises a cellular phone.

10. The method of claim 1, wherein the communication device comprises a PDA.

11. The method of claim 1, wherein the communication device comprises a portable computer.

12. The method of claim 1, wherein the context information comprises information input by a user using an input interface of the communication device.

13. The method of claim 1, wherein the context information comprises information collected by the communication device without direct user input.

14. The method of claim 1, wherein the mapping is adjusted upon receiving new context information.

15. The method of claim 1, wherein the mapping comprises a matrix of values that relate events to functions of the communication device.

16. The method of claim 1, wherein the mapping comprises a set of templates that specify one or more functions for a plurality of events, where the mapping is according to a template selected based on the context information.

17. The method of claim 1, wherein the mapping comprises a decision tree for determining a function for an event based on context information.

18. The method of claim 1, wherein a separate mapping is used for each of a plurality of sessions running on the communication device.

19. The method of claim 1, further comprising:
storing historical data describing historical user activity with the communication device; and
adjusting the mapping based on the historical data.

20. The method of claim 1, further comprising:
storing historical data describing historical application activity; and
adjusting the mapping based on the historical data.

21. The method of claim 1, further comprising:
storing historical data describing historical network activity; and
adjusting the mapping based on the historical data.

22. The method of claim 1, wherein one or more of the functions are configured to be executed on a main processor of the communication device and one or more of the functions are configured to be executed on an adjunct processor coupled to the communication device.

23. The method of claim 1, wherein one or more of the functions are configured to be executed on a local computer system connected to the communication device.

24. The method of claim 1, wherein one or more of the functions are configured to be executed on a remote computer system coupled to the communication device via a communication network.

25. A computer program product for implementing context-dependent functionality in a communication device, the computer program product comprising a computer-readable medium containing computer program code for performing the method comprising:
associating a set of events with a set of one or more functions of the communication device according to a mapping;
tracking context information related to the communication device;
adjusting the mapping dynamically and automatically based on the tracked context information of the communication device; and
responsive to observing an event, invoking one or more functions associated with the event according to the mapping.

26. The computer program product of claim 25, wherein one or more of the functions are applications that access a functionality of the communication device.

27. The computer program product of claim 25, wherein one or more of the functions are library commands that access a functionality of the communication device.

28. The computer program product of claim 25, wherein one or more of the functions are a protocol stack.

29. The computer program product of claim 25, wherein one or more of the events are application requests.

30. The computer program product of claim 25, further comprising:
accumulating user data during operation of the communication device.

31. The computer program product of claim 30, wherein invoking the functions comprises passing at least some of the accumulated user data to the invoked function.

32. The computer program product of claim 25, wherein the communication device is a mobile communication device.

33. The computer program product of claim 25, wherein the communication device comprises a cellular phone.

34. The computer program product of claim 25, wherein the communication device comprises a PDA.

35. The computer program product of claim 25, wherein the communication device comprises a portable computer.

36. The computer program product of claim 25, wherein the context information comprises information input by a user using an input interface of the communication device.

37. The computer program product of claim 25, wherein the context information comprises information collected by the communication device without direct user input.

38. The computer program product of claim 25, wherein the mapping is adjusted upon receiving new context information.

39. The computer program product of claim 25, wherein the mapping comprises a matrix of values that relate events to functions of the communication device.

40. The computer program product of claim 25, wherein the mapping comprises a set of templates that specify one or more functions for a plurality of events, where the mapping is according to a template selected based on the context information.

41. The computer program product of claim 25, wherein the mapping comprises a decision tree for determining a function for an event based on context information.

42. The computer program product of claim 25, wherein a separate mapping is used for each of a plurality of sessions running on the communication device.

43. The computer program product of claim 25, the method further comprising:
storing historical data describing historical user activity with the communication device; and
adjusting the mapping based on the historical data.

44. The computer program product of claim 25, the method further comprising:
storing historical data describing historical application activity; and
adjusting the mapping based on the historical data.

45. The computer program product of claim 25, the method further comprising:
storing historical data describing historical network activity; and
adjusting the mapping based on the historical data.

46. The computer program product of claim 25, wherein one or more of the functions are configured to be executed on a main processor of the communication device and one or more of the functions are configured to be executed on an adjunct processor coupled to the communication device.

47. The computer program product of claim 25, wherein one or more of the functions are configured to be executed on a local computer system connected to the communication device.

48. The computer program product of claim 25, wherein one or more of the functions are configured to be executed on a remote computer system coupled to the communication device via a communication network.

49. A communication device for performing context-dependent functionalities, communication device comprising a computer-readable medium containing computer program code comprising:
a set of functions, each function for providing a capability of the communication device;
a mapping of one or more events to the functions;
a context engine configured to receive context information about the communication device during operation of the communication device and to adjust the mapping based on the received context information about the device; and
an event handler configured to receive an event and invoke one or more functions associated with the event according to the mapping.

50. The device of claim 49, wherein one or more of the functions are applications that access a functionality of the communication device.

51. The device of claim 49, wherein one or more of the functions are library commands that access a functionality of the communication device.

52. The device of claim 49, wherein one or more of the functions are a protocol stack.

53. The device of claim 49, wherein one or more of the events are application requests.

54. The device of claim 49, further comprising:
a data cataloger configured to receive user data during operation of the device; and
a data catalog for storing the user data.

55. The device of claim 54, wherein the event handler is configured to pass at least some of the user data to the invoked function.

56. The device of claim 49, wherein the communication device is a mobile communication device.

57. The device of claim 49, wherein the communication device comprises a cellular phone.

58. The device of claim 49, wherein the communication device comprises a PDA.

59. The device of claim 49, wherein the communication device comprises a portable computer.

60. The device of claim 49, wherein the context information comprises information input by a user using an input interface of the communication device.

61. The device of claim 49, wherein the context information comprises information collected by the communication device without direct user input.

62. The device of claim 49, wherein the mapping comprises a matrix of values that relate events to functions of the communication device.

63. A communication device comprising:
an event interface for generating events based on observed activities related to the communication device;
a means for dynamically and automatically associating events that may be generated with a set of capabilities of the device based on context information about the communication device;
a means for invoking a capability of the device in response to an event, the capability selected according to the means for associating.

64. The device of claim 63, further comprising:
a means for accumulating user data received during operation of the computing device; and
a means for using the user data in connection with the invoked capability of the device.

65. The device of claim 63, wherein the device is a mobile communications device.

66. The device of claim 63, wherein the device is a cellular phone.

67. The device of claim 63, wherein the device is a PDA.

68. The device of claim 63, wherein the device is a portable computer.

69. The method of claim 1, wherein one or more of the functions are user interface widgets for producing a graphical output on a display of the communication device.

70. The communication device of claim 49, wherein one or more of the functions are user interface widgets for producing a graphical output on a display of the communication device.
